(19) United States
(12) Patent Application Publication
(10) Pub. No.: US 2010/0053017 A1
(43) Pub. Date: Mar. 4, 2010

(54) ANTENNA ELEMENT AND ANTENNA APPARATUS INCLUDING THE SAME

(75) Inventors: Shigemi Kurashima, Shinagawa (JP); Masahiro Yanagi, Shinagawa (JP); Takashi Arita, Shinagawa (JP)

Correspondence Address: IPUSA, P.L.L.C, 1054 31ST STREET, N.W., Suite 400, Washington, DC, 20007, US

(73) Assignee: FUJITSU COMPONENT LIMITED

(21) Appl. No.: 12/493,318

(22) Filed: Jun. 29, 2009

(30) Foreign Application Priority Data
Sep. 2, 2008 (JP) 2008225205

(51) Int. Cl. H01Q 1/36; H01Q 1/48

(52) U.S. Cl. 343/848; 343/898; 343/908

(57) ABSTRACT

An antenna element is disclosed that includes a first antenna portion having a hemispherical shape; and a second antenna portion having a conical shape, and a feeding portion disposed at an apex of the conical shape and configured to be fed with an electrical power from an external power source, wherein the first antenna portion and the second antenna portion are engaged with each other to form the antenna element having a teardrop shape.

### BACKGROUND OF THE INVENTION

1. Field of the Invention

The present invention relates to an antenna element used in Ultra Wide Band (UWB) communication, and an antenna apparatus including the same.

2. Description of the Related Art

UWB communication enables an ultra fast communication by using a GHz frequency band. In 2002, the U.S. Federal Communication Commission (FCC) approved usage of the UWB. Since then, an application of the UWB to a portable electronic device and a high precision positioning system has been expected. An ultra wide frequency band antenna apparatus, which has a teardrop shaped antenna element and is suitable for a GHz frequency band, has been developed.

Patent Document 1: Japanese Patent Laid-Open Publication No. 2004-129209

However, it is difficult to manufacture an antenna element which is die cast integrally in a teardrop shape.

### SUMMARY OF THE INVENTION

It is a general object of the present invention to provide an antenna element and an antenna apparatus including the same configured to be manufactured easily at a low cost and to provide a low Voltage Standing Wave Ratio (VSWR) value.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an antenna element and an antenna apparatus including the same particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an antenna element including: a first antenna portion having a hemispherical shape; and a second antenna portion having a conical shape, and a feeding portion disposed at an apex of the conical shape and configured to be fed with electrical power from an external power source, wherein the first antenna portion and the second antenna portion are engaged with each other to form the antenna element having a teardrop shape.

Other objects and further features of the present invention will be apparent from the following detailed description when read in conjunction with the accompanying drawings.

### BRIEF DESCRIPTION OF THE DRAWINGS

FIG. 1A is an exploded drawing of an antenna element according to embodiment 1 shown in perspective view;

FIG. 1B is a schematic drawing of the antenna element according to embodiment 1 shown in perspective view;

FIG. 1C is an exploded drawing of an antenna element according to another configuration example of embodiment 1 shown in perspective view;

FIG. 2 is a schematic drawing of an antenna apparatus according to embodiment 1 shown in perspective view;

FIG. 3 is an exploded drawing of an antenna element according to embodiment 2 shown in perspective view;

FIG. 4 is an exploded drawing of an antenna element according to embodiment 3 shown in perspective view; and

FIG. 5 is an exploded drawing of an antenna element according to another configuration example of embodiment 3 shown in perspective view.

### DESCRIPTION OF THE PREFERRED EMBODIMENTS

In the following, embodiments of the present invention will be described with reference to the accompanying drawings.

### Embodiment 1

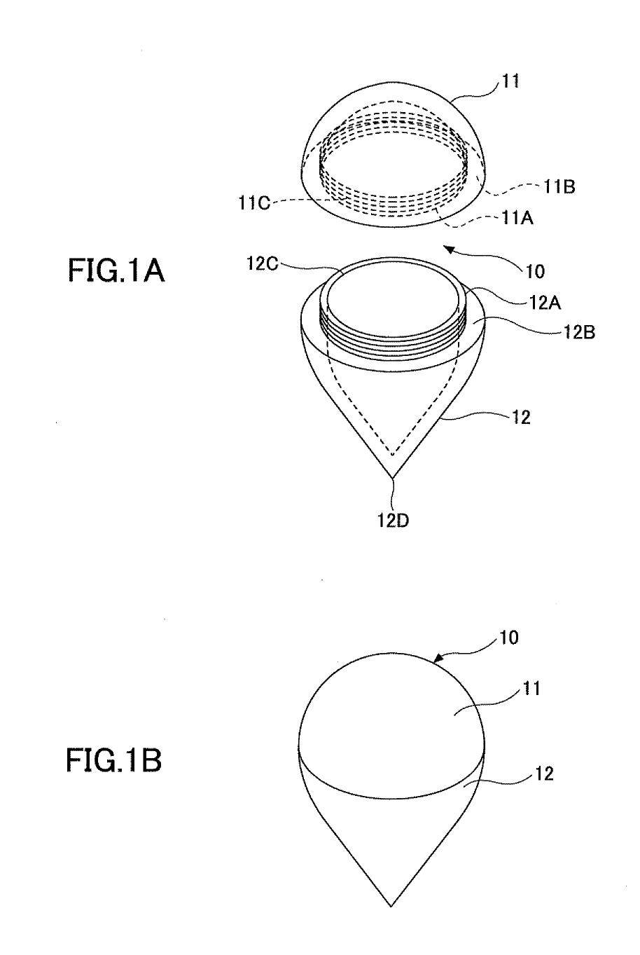

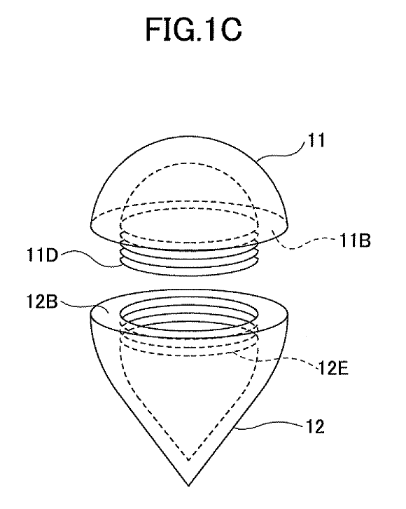

FIG. 1A is an exploded drawing of an antenna element according to embodiment 1 shown in perspective view. FIG. 1B is a schematic drawing of the antenna element according to embodiment 1 shown in perspective view. FIG. 1C is an exploded drawing of an antenna element according to another configuration example of embodiment 1 shown in perspective view.

As shown in FIG. 1A, an antenna element 10 includes an antenna portion 11 having a hemispherical cup shape, and an antenna portion 12 having a conical cup shape. The antenna portion 11 constitutes a first antenna portion, and the antenna portion 12 constitutes a second antenna portion. An outer shape of the antenna portion 11 and an outer shape of the antenna portion 12 are configured to form a continuous outer surface of a teardrop shape of the antenna element 10 when the antenna portion 11 and the antenna portion 12 are engaged with each other.

The antenna portion 11 includes an opening 11A formed in an engaging surface 11B, and a thread groove portion 11C formed on an inner surface of the antenna portion 11. The thread groove portion 11C is formed with the opening 11A. The engaging surface 11B constitutes an engaging portion of the hemispherical shape and has an annular shape.

The antenna portion 11 is die cast from a composition metal which may include, for example, zinc, aluminum, magnesium, and copper. The thread groove portion 11C may be formed by die casting at the same time as the antenna portion 11.

The antenna portion 12 includes a hollow screw portion 12A formed on an engaging surface 12B. The hollow screw portion 12A extends from the engaging surface 12B, and includes an opening 12C. The hollow screw portion 12A is engaged with the thread groove portion 11C. The hollow screw portion 12A may be formed by die casting at the same time as the antenna portion 12. The engaging surface 12B constitutes an engaging portion of the conical shape and has an annular shape.

The antenna portion 12 includes a feeding portion 12D formed at an apex of the conical cup shape of the antenna portion 12. A cable core (not shown) of a coaxial cable is connected to the feeding portion 12D in order to feed electrical power thereto from an external power source.

The antenna portion 12 is die cast from a composition metal which may include, for example, zinc, aluminum, magnesium, and copper.

The antenna portions 11 and 12 are engaged by threadably engaging the thread groove portion 11C and the hollow screw portion 12A to each other, and form the antenna element 10 having the teardrop shape shown in FIG. 1B.

According to the embodiment 1, the teardrop shape of the antenna element 10 is formed by engaging the hemispherical cup shape of the antenna portion 11 and the conical cup shape of the antenna portion 12. However, the teardrop shape of the antenna element 10 may not exactly be in the shape formed by engaging the hemispherical cup shape and the conical cup shape. The shape of the antenna portion 11 may not exactly be a hemispherical cup shape. The shape of the antenna portion 12 may not exactly be a conical cup shape.

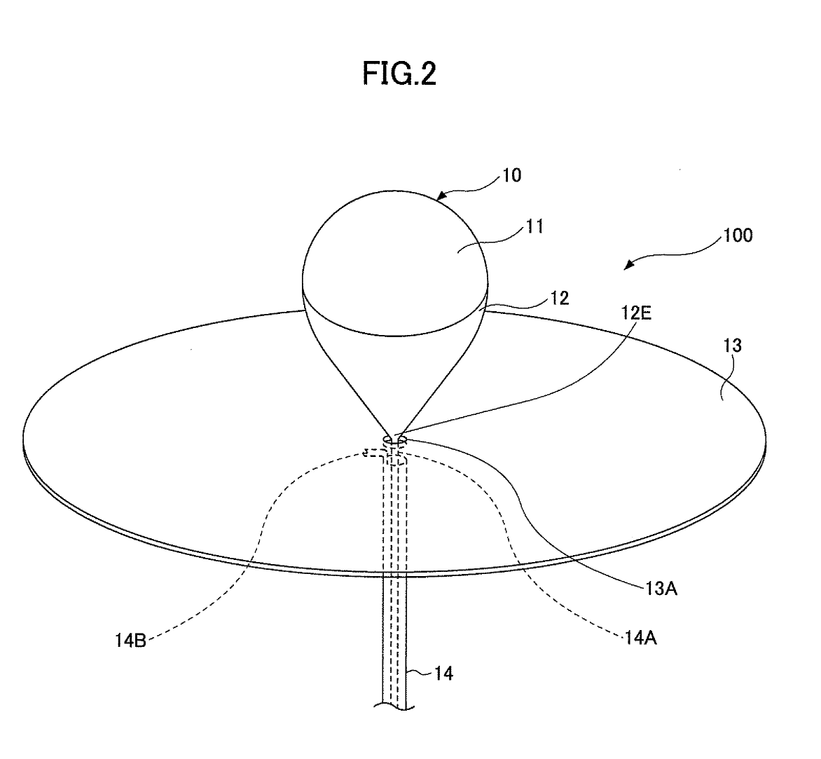

FIG. 2 is a schematic drawing of an antenna apparatus according to embodiment 1 shown in perspective view.

An antenna apparatus 100 includes the antenna element 10 and a ground portion 13.

The ground portion 13 constitutes a ground plane of which an electrical potential is kept to the ground potential. The ground portion 13 is coupled with the antenna element 10.

The ground portion 13 includes an opening 13A through which a cable core 14A of a coaxial cable 14 is connected to the feeding portion 12D in order to feed electrical power to the feeding portion 12D. A shielded line 143 of the coaxial cable 14 is connected to the back surface of the ground portion 13. Thus, the electrical potential of the ground portion 13 is kept to the ground potential.

Although the ground portion 13 having a circular plate shape is shown in FIG. 2, the shape of the ground portion 13 is not limited to the circular plate shape. The ground portion 13 may be formed of a plate with any shape in plane view. A thickness of the ground portion 13 may be set to any value.

The antenna apparatus 100 including the antenna element 10 having the teardrop shape as described above provides a VSWR value of about 2.0 to about 3.0 within the frequency band from about 3.0 to about 10.0 GHz. The antenna apparatus 100 provides directional characteristics which is uniform in 360 degrees, because the antenna apparatus 100 has a uniform shape in plane view. The antenna apparatus 100 provides a high quality UWB communication.

The antenna element 10 described above can be assembled only by threadably engaging the antenna portion 11 having the hemispherical cup shape and the antenna portion 12 having the conical cup shape. The antenna portions 11 and 12 are manufactured by a die casting method.

Thus, the embodiment 1 of the present invention can provide the antenna element 10 and the antenna apparatus 100 used in UWB communication at low cost and with a high performance.

As described above, the antenna portions 11 and 12 are die cast from the composition metal. However, it will be appreciated that the antenna portions 11 and 12 are not limited to be made of the composition metal. For example, the antenna portions 11 and 12 may be made of molded resins with metallizing coatings, and engaged to be electrically connected to each other. In this case, the antenna portions 11 and 12 made of the molded resins with the metallizing coatings can provide the same performance as those made of the composition metal.

As described above, the thread groove portion 11C is formed with the antenna portion 11, and the hollow screw portion 12A is formed with the antenna portion 12. However, it will be appreciated that a thread groove portion 12E may be alternately formed with the antenna portion 12, and a hollow screw portion 11D may be alternately formed with the antenna portion 11 as shown in FIG. 1C.

### Embodiment 2

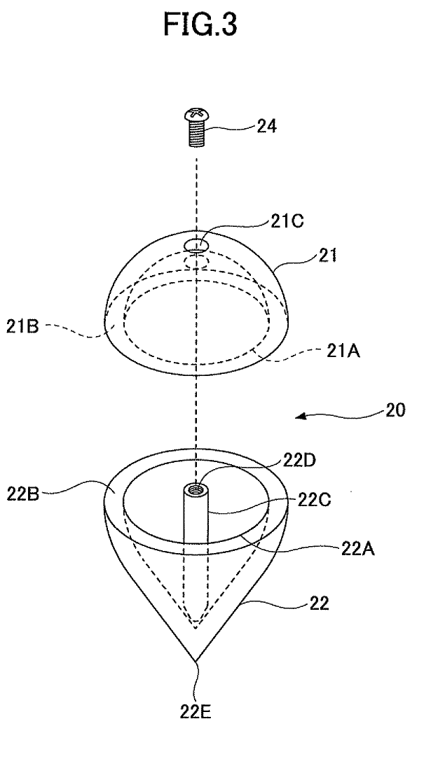

FIG. 3 is an exploded drawing of an antenna element according to embodiment 2 shown in perspective view.

As shown in FIG. 3, an antenna element 20 includes an antenna portion 21 having a hemispherical cup shape, and an antenna portion 22 having a conical cup shape. The antenna portion 21 constitutes a first antenna portion, and the antenna portion 22 constitutes a second antenna portion.

The antenna portion 21 includes an opening 21A formed in an engaging surface 21B, and an opening 21C, through which a screw 24 is inserted, formed on the top of the antenna portion 21. The engaging surface 21B constitutes an engaging portion of the hemispherical shape and has an annular shape.

The top portion at which the opening 21C is formed becomes a null point of the antenna element 20.

The antenna portion 21 is die cast from a composition metal which may include, for example, zinc, aluminum, magnesium, and copper. The opening 21C may be formed by die casting at the same time the antenna portion 21 is formed.

The antenna portion 22 includes an opening 22A formed in an engaging surface 22B, and a pole 22C extended from an inner surface of the antenna portion 22. A threaded groove portion 22D is formed at a top portion of the pole 22C. The engaging surface 22B constitutes an engaging portion of the conical shape and has an annular shape.

The antenna portion 22 includes a feeding portion 22E formed at an apex of the conical cup shape of the antenna portion 22. A cable core not shown) of a coaxial cable is connected to the feeding portion 22E in order to feed electrical power thereto from an external power source.

The antenna portion 22 is die cast from a composition metal which may include, for example, zinc, aluminum, magnesium, and copper. The opening 22A, the pole 22C, and the threaded groove portion 22D may be formed by die casting at the same time the antenna portion 22 is formed.

The antenna portions 21 and 22 are engaged by threadably engaging the screw 24 into the threaded groove portion 22D, and form an antenna element 20 having a teardrop shape.

An antenna apparatus according to embodiment 2 includes the antenna element 20 and the ground portion 13 shown in FIG. 2. The antenna apparatus according to embodiment 2 provides the same characteristics and the same performance as the antenna apparatus 100 according to embodiment 1.

Thus, the embodiment 2 of the present invention can provide the antenna element 20 and the antenna apparatus used in UWB communication at low cost and with a high performance.

### Embodiment 3

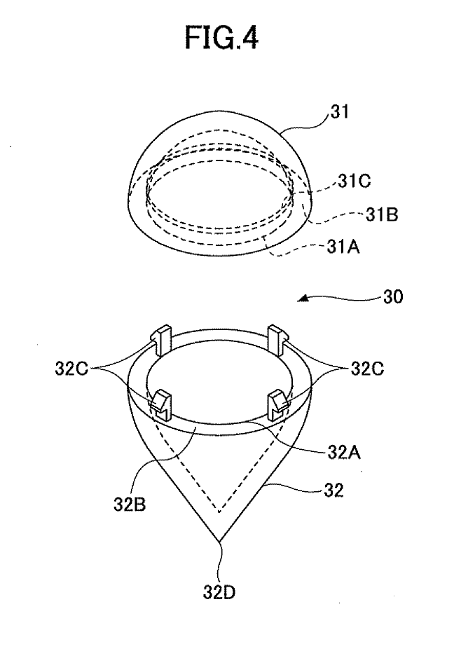

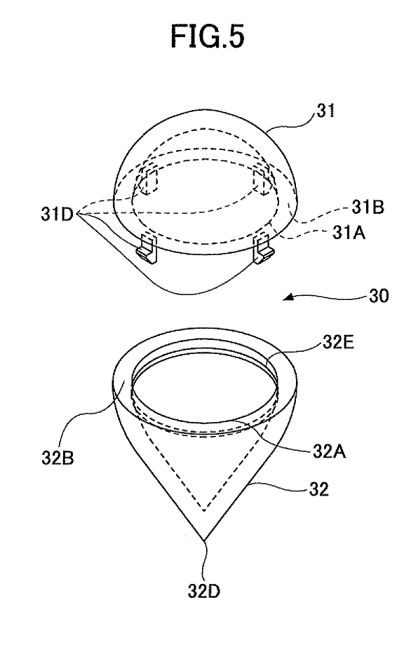

FIG. 4 is an exploded drawing of an antenna element according to embodiment 3 shown in perspective view. FIG. 5 is an exploded drawing of an antenna element according to another configuration example of embodiment 3 shown in perspective view.

As shown in FIG. 4, an antenna element 30 includes an antenna portion 31 having a hemispherical cup shape, and an antenna portion 32 having a conical cup shape. The antenna portion 31 constitutes a first antenna portion, and the antenna portion 32 constitutes a second antenna portion.

The antenna portion 31 includes an opening 31A formed in an engaging surface 31B, and a bump portion 31C formed on an inner surface of the antenna portion 31. The bump portion 31C is formed along the opening 31A. The bump portion 31C is capable of engaging tooth portions 32C formed with the antenna portion 32 when the antenna portions 31 and 32 are engaged to each other. The engaging surface 31B constitutes an engaging portion of the hemispherical shape and has an annular shape. The bump portion 31C constitutes a tooth engaging portion.

The antenna portion 31 is die cast from a composition metal which may include, for example, zinc, aluminum, magnesium, and copper. The opening 31A and the bump portion 31C may be formed by die casting at the same time as the antenna portion 31.

The antenna portion 32 includes an opening 32A formed in an engaging surface 32B, and the tooth portions 32C extended from the engaging surface 32B. The tooth portions 32C are extended in a direction parallel to a symmetrical axis of the conical cup shape of the antenna portion 32. The axis of the conical cup shape of the antenna portion 32 is the same as that of the teardrop shape of the antenna element 30. The engaging surface 32B constitutes an engaging portion of the conical shape and has an annular shape.

The antenna portion 32 includes a feeding portion 32D formed at an apex of the conical cup shape of the antenna portion 32. A cable core (not shown) of a coaxial cable is connected to the feeding portion 32D in order to feed electrical power thereto from an external power source.

The antenna portion 32 is die cast from a composition metal which may include, for example, zinc, aluminum, magnesium, and copper. The opening 32A and the tooth portions 32C may be formed by die casting at the same time the antenna portion 32 is formed.

The antenna portions 31 and 32 are engaged by engaging the tooth portions 32C of the antenna portion 32 to the bump portion 31C of the antenna portion 31, and form an antenna element 30 having a teardrop shape.

An antenna apparatus according to embodiment 3 includes the antenna element 30 and the ground portion 13 shown in FIG. 2. The antenna apparatus according to embodiment 3 provides the same characteristics and the same performance as the antenna apparatus 100 according to embodiment 1.

Thus, the embodiment 3 of the present invention can provide the antenna element 30 and the antenna apparatus used in UWB communication at low cost and with a high performance.

As described above, the bump portion 31C is formed with the antenna portion 31, and the tooth portions 32C are formed with the antenna portion 32. However, it will be appreciated that a bump portion 32E may be alternately formed with the antenna portion 32, and tooth portions 31D may be alternately formed with the antenna portion 31 as shown in FIG. 5.

Further, the present invention is not limited to these embodiments, but variations and modifications may be made without departing from the scope of the present invention.

The present application is based on Japanese Priority Application No. 2008-225205 filed on Sep. 2, 2008 with the Japanese Patent Office, the entire contents of which are hereby incorporated by reference.

What is claimed is:

1. An antenna element comprising:
a first antenna portion having a hemispherical shape; and
a second antenna portion having a conical shape, and a feeding portion disposed at an apex of the conical shape and configured to be fed with electrical power from an external power source,
wherein the first antenna portion and the second antenna portion are engaged to each other to form the antenna element having a teardrop shape.

2. The antenna element as claimed in claim 1, wherein the first antenna portion includes a threaded groove portion formed in an engaging portion of the hemispherical shape, and the second antenna portion includes a screw portion formed in an engaging portion of the conical shape, and wherein the first antenna portion and the second antenna portion are engaged by engaging the screw portion to the threaded groove portion.

3. The antenna element as claimed in claim 1, wherein the first antenna portion includes a screw portion formed in an engaging portion of the hemispherical shape, and the second antenna portion includes a threaded groove portion formed in an engaging portion of the conical shape, and wherein the first antenna portion and the second antenna portion are engaged by engaging the screw portion to the threaded groove portion.

4. The antenna element as claimed in claim 1, wherein the first antenna portion includes an opening at the top of the hemispherical shape, and the second antenna portion includes a threaded groove portion formed in an inner portion of the second antenna portion, and wherein the first antenna portion and the second antenna portion are engaged by engaging a screw into the threaded groove portion via the opening.

5. The antenna element as claimed in claim 1, wherein the first antenna portion includes a plurality of tooth portions formed in an engaging portion of the hemispherical shape, and the second antenna portion includes a tooth engaging portion formed in an engaging portion of the conical shape capable of engaging the tooth portions, and wherein the first antenna portion and the second antenna portion are engaged by engaging the tooth portions to the tooth engaging portion.

6. The antenna element as claimed in claim 1, wherein the second antenna portion includes a plurality of tooth portions formed in an engaging portion of the conical shape, and the first antenna portion includes a tooth engaging portion formed in an engaging portion of the hemispherical shape capable of engaging the tooth portions, and wherein the first antenna portion and the second antenna portion are engaged by engaging the tooth portions to the tooth engaging portion.

7. An antenna apparatus comprising:
the antenna element as claimed in claim 1; and
a ground plane coupled with the antenna element.
